(19) United States
(12) Patent Application Publication
(10) Pub. No.: US 2005/0139407 A1
(43) Pub. Date: Jun. 30, 2005

(54) Motorcycle with coaxial swingarm pivot and drive sprocket

(76) Inventor: Michael Czysz, Portland, OR (US)

Correspondence Address: RICHARD C. CALDERWOOD, 2775 NW 126TH AVE, PORTLAND, OR, 97229-8381, US

(21) Appl. No.: 11/050,389

(22) Filed: Feb. 2, 2005

Related U.S. Application Data
(63) Continuation-in-part of application No. 10/633,296, filed on Jul. 31, 2003.
(63) Continuation-in-part of application No. 11/001,164, filed on Dec. 1, 2004.
(63) Continuation-in-part of application No. 10/704,929, filed on Nov. 10, 2003.

(51) Int. Cl. B62M 7/00

(52) U.S. Cl. 180/227

(57) ABSTRACT

A motorcycle in which the swingarm pivot is coaxial with the sprocket shaft, and the sprocket is laterally outside the swingarm structures at the swingarm pivot. The swingarm pivot is located in the engine case, such as where the cylinder block meets the crankcase. An optional slipper clutch is located in the crankcase, such as where an upper crankcase half meets a lower crankcase half, and drives the sprocket shaft.

### RELATED APPLICATIONS

This application is a continuation-in-part of U.S. patent application Ser. No. 10/633,296 entitled “Vehicle with Separate Gearbox Clutch and Back-Torque-Limiting Slipper Clutch” filed Jul. 31, 2003 by Michael Czysz, and a continuation-in-part of U.S. patent application Ser. No. 11/001,164 entitled “Motorcycle Rear Suspension with Linear Spring Rate and Linkage Controlled Shock Rate” filed Dec. 1, 2004 by Michael Czysz, and a continuation-in-part of U.S. patent application Ser. No. 10/704,929 entitled “Motorcycle with Dual Drive Chains” filed Nov. 10, 2003 by Joshua S. Bryan, all of which are commonly assigned with the present application.

### BACKGROUND OF THE INVENTION

1. Technical Field of the Invention

This invention relates generally to motorcycle rear suspension, and more specifically to swingarm pivot location.

2. Background Art

Motorcycles are most commonly chain driven. The rear wheel has a large sprocket of approximately 48 teeth, and the engine's output shaft has a small sprocket of approximately 16 teeth. The front sprocket is coupled to an output shaft or sprocket shaft of the engine's transmission or gearbox. Some motorcycles use belts rather than chains, but in a similar geometric arrangement.

Motorcycles typically include a rear swingarm which has a rear end coupled to the rear wheel, and a front end coupled to the frame or to the engine at a pivot point. The location of the swingarm pivot is a key factor in the overall performance and characteristics of the motorcycle's rear suspension.

Most commonly, the swingarm pivot is located to the rear of the sprocket shaft, such that the swingarm pivot lies within the perimeter of the chain. One undesirable side-effect of this geometry is that, as swingarm rises and falls, rotating up and down around its swingarm pivot, the chain tension changes significantly. In many applications, the tension changes so much that a separate chain tensioner mechanism is required, to prevent the chain from jumping sprocket teeth when the chain tension is at its loosest. The different locations of the sprocket shaft and the swingarm pivot have other effects, as well, such as contributing to “squat” or “rise” of the rear end under acceleration.

FIG. 6 is a photograph of a 2005 Yamaha R1 sportbike with its bodywork removed. The sprocket shaft is approximately at location 102; it is hidden by the sprocket cover which protects the rider from the sprocket and chain. The swingarm pivots in the frame at location 104.

FIG. 7 is a photograph of a 2005 Yamaha YZF450F dirtbike. The sprocket shaft is at location 106, and the swingarm pivots at location 108.

FIG. 8 is a photograph from Tony Foale's excellent motorcycle suspension website http://www.tonyfoale.com and illustrates what Mr. Foale indicates is a Kawasaki Z1R engine (evidently from the 1970s). Mr. Foale indicates at http://tonyfoale.com/gallery/StrFrame/home.htm that the Z1R's “swingarm was concentric with the gearbox sprocket to maintain constant chain tension. Two magnesium castings were made to hold the bearings for the swingarm pivot. One replaced the clutch cover and can be seen in [FIG. 8], the other covered the sprocket and incorporated the clutch release actuating lever.” In other words, the Z1R's swingarm pivots 110 were outboard from the sprocket, and were not directly coupled to the engine casings.

### BRIEF DESCRIPTION OF THE DRAWINGS

FIG. 1 is a generally side view showing one embodiment of a motorcycle engine having a sprocket shaft which is coaxial with its swingarm pivot.

FIG. 2 is a generally top view of the motorcycle engine of FIG. 1 with various engine components removed for better visibility of others.

FIG. 3 is a generally front cross-sectioned view of the motorcycle engine of FIG. 1, showing the coaxial relationship of the sprocket shaft and the swingarm pivot.

FIG. 4 is a generally front cross-sectioned view of another embodiment of a motorcycle engine having a pair of sprocket shafts—one out each side of the engine—which are coaxial with the swingarm pivots at their respective sides of the engine.

FIG. 5 shows a motorcycle according to one embodiment of this invention.

FIG. 6 shows a 2005 Yamaha R1 motorcycle, in which the swingarm pivot is behind the sprocket shaft.

FIG. 7 shows a 2005 Yamaha YZF450F motorcycle, in which the swingarm pivot is behind the sprocket shaft.

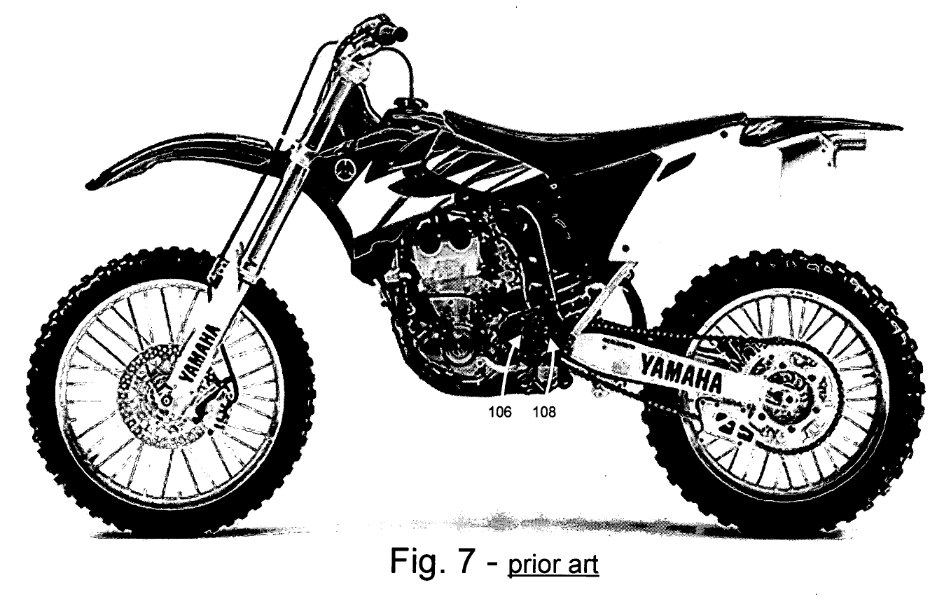

FIG. 8 shows a 1970s era Kawasaki Z1R motorcycle engine which had its swingarm pivots outboard of its sprocket in lightweight castings which were bolted to the engine.

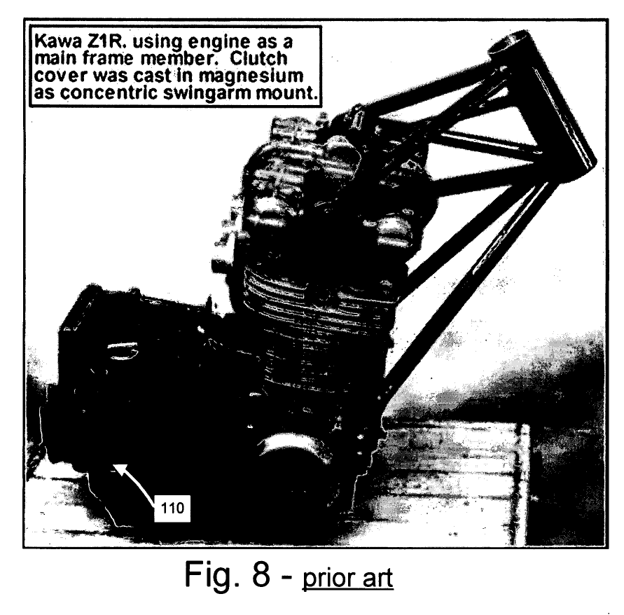

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

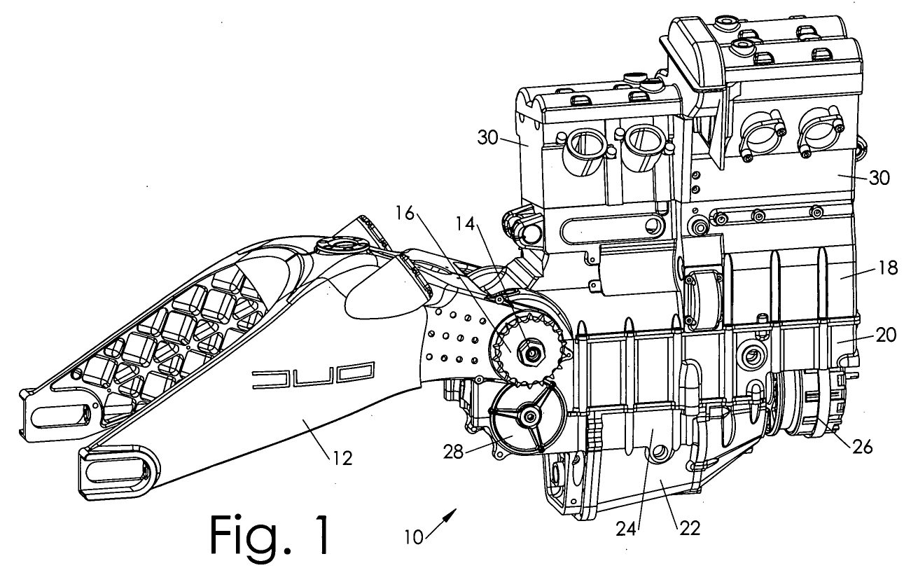

FIG. 1 illustrates a motorcycle engine 10 and swingarm 12 according to one embodiment of this invention. The engine includes an output shaft or sprocket shaft 14 to which is coupled a chain drive sprocket 16 (or belt drive wheel in belt-driven applications). The engine includes a cylinder block 18 which is coupled to a crankcase 20. In one embodiment, the sprocket shaft exits the engine at a mating seam between the cylinder block and the crankcase.

The crankcase may include a separate gearbox case 22 which can be dropped away without removing the various gearbox components (not shown) from their respective bearings and other retainers (not shown). In one embodiment, the crankcase may include a lower crankcase half 24 which is disposed between the upper crankcase half 20 and the gearbox case. In one embodiment, the engine includes a primary gearbox clutch 26 and a separate slipper clutch unit 28. In one embodiment, the slipper clutch unit is disposed at the seam between the upper and lower crankcase halves. The engine further includes one or more heads 30 coupled to the cylinder block to provide intake, exhaust, valving, and so forth as is conventionally known in engines.

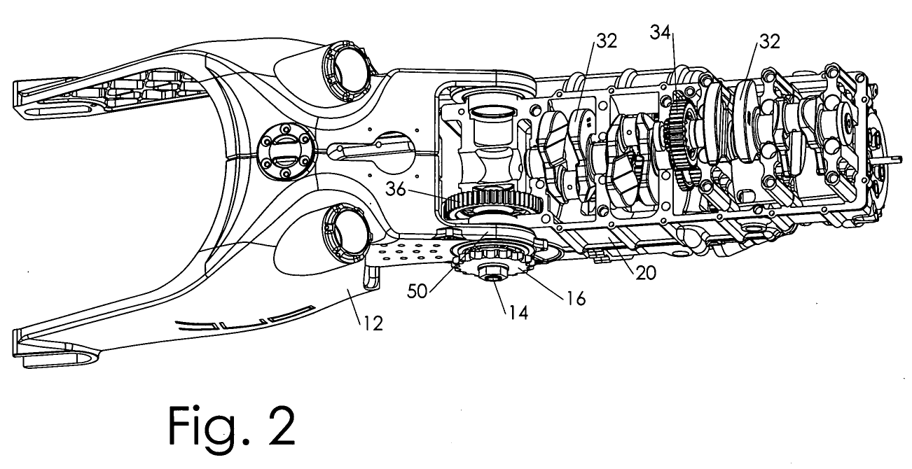

FIG. 2 illustrates the motorcycle engine 10 and swingarm 12 with the cylinder block and heads removed, providing visibility into some of the internal engine components. The engine includes one or more crankshafts 32 which are driven by pistons (not shown) in the cylinder block. Power is transmitted from the crankshafts down into the gear box by e.g. a gear train 34. After passing through the gearbox, power is transmitted to a final drive output gear 36 which is coupled to the output shaft 14, which in turn drives the sprocket 16.

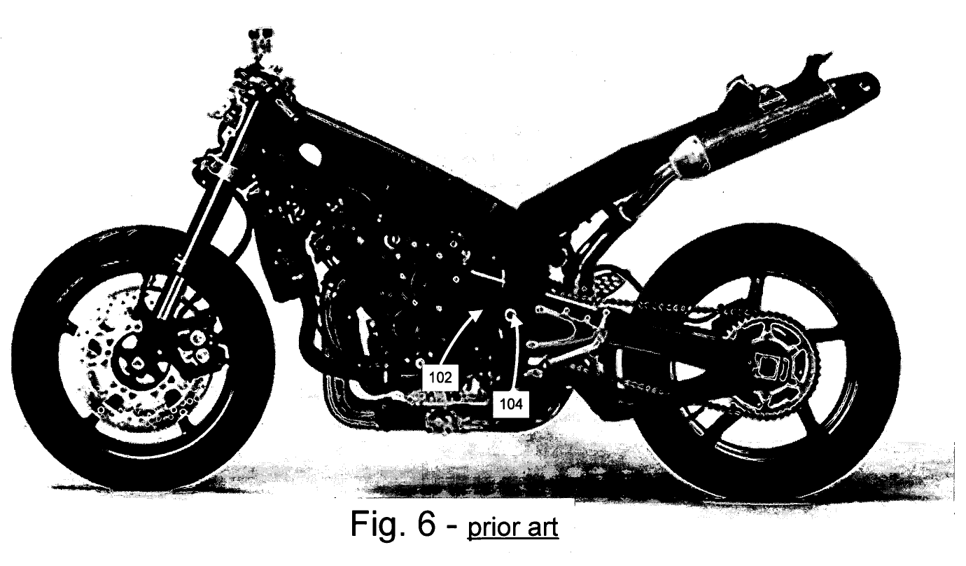

The structure 37 of the swingarm which extends about the swingarm pivot is inboard of the sprocket 16. In other words, the mounting point of the swingarm is narrower from the midline of the swingarm, than is the sprocket. This enables the swingarm to be coupled directly into the structure of the crankcase and/or cylinder block, whereas in the few prior art examples of coaxial swingarm mounting, the swingarm pivots were outside the sprocket and the swingarm was coupled into to an intermediate subframe or casing that is coupled to a frame or engine casing. For example, as shown in FIG. 6, in the Kawasaki Z1R, the swingarm mounted to the outside of the clutch cover, which was in turn bolted to the engine casings. In Bimota Tesi motorcycles, the swingarm mounted to a subframe plate that was bolted to the frame and was not coupled to the engine at all; the swingarm pivot was well outside the drive sprocket.

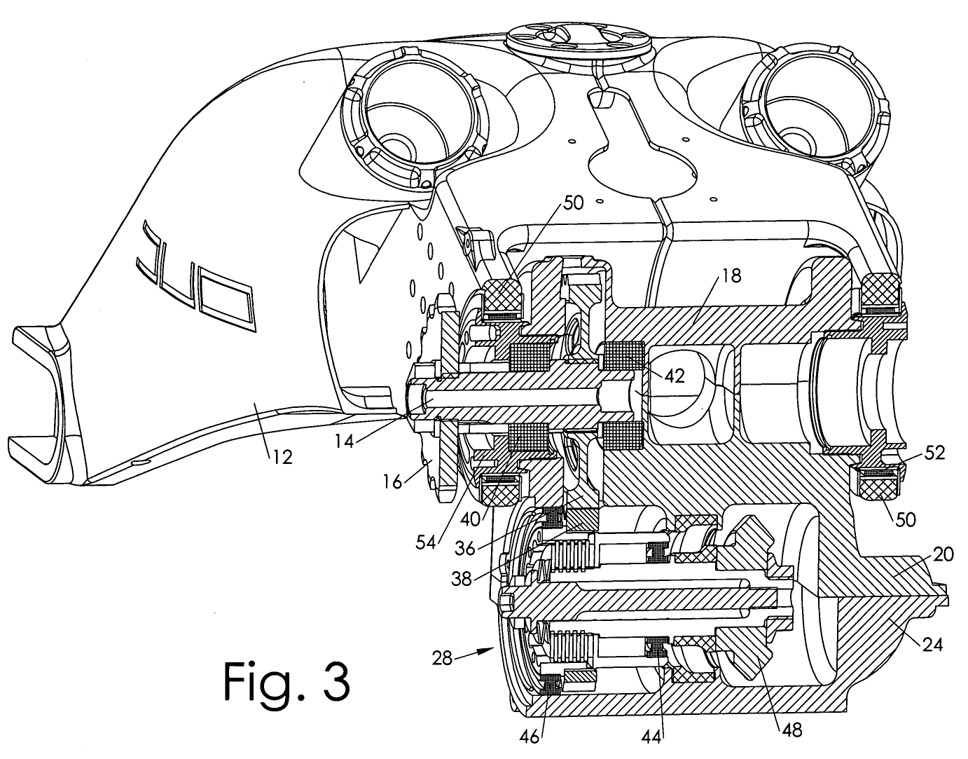

FIG. 3 illustrates the motorcycle engine 10 and swingarm of FIG. 1 in cutaway or cross-sectioned view. The sprocket shaft 14 carries the sprocket 16 and exits the engine at the seal where the crankcase 20 meets the cylinder block 18. The sprocket shaft is driven by a final output gear 36 which is driven by a gear 38 coupled to the slipper clutch 28. The slipper clutch is disposed at the seam or gasket where the upper crankcase half 20 meets the lower crankcase half 24.

The sprocket shaft rotates in bearings 40, 42 which are journaled in the crankcase and engine block. The slipper clutch rotates in a bearings 44, 46 which are journaled in the crankcase halves. In one embodiment, in which the gearbox shafts (not shown) are oriented longitudinally with respect to the direction of travel of the motorcycle, the slipper clutch is driven by a bevel gear 48 which mates with another bevel gear (not shown) coupled to the gearbox secondary shaft (not shown).

The swingarm includes a portion 50 which rotates on bearings 52 which are coupled to the engine by mounting brackets 54 which, in one embodiment, thread into the engine. The sprocket shaft exits the assembly substantially coaxial with the swingarm pivot bearings.

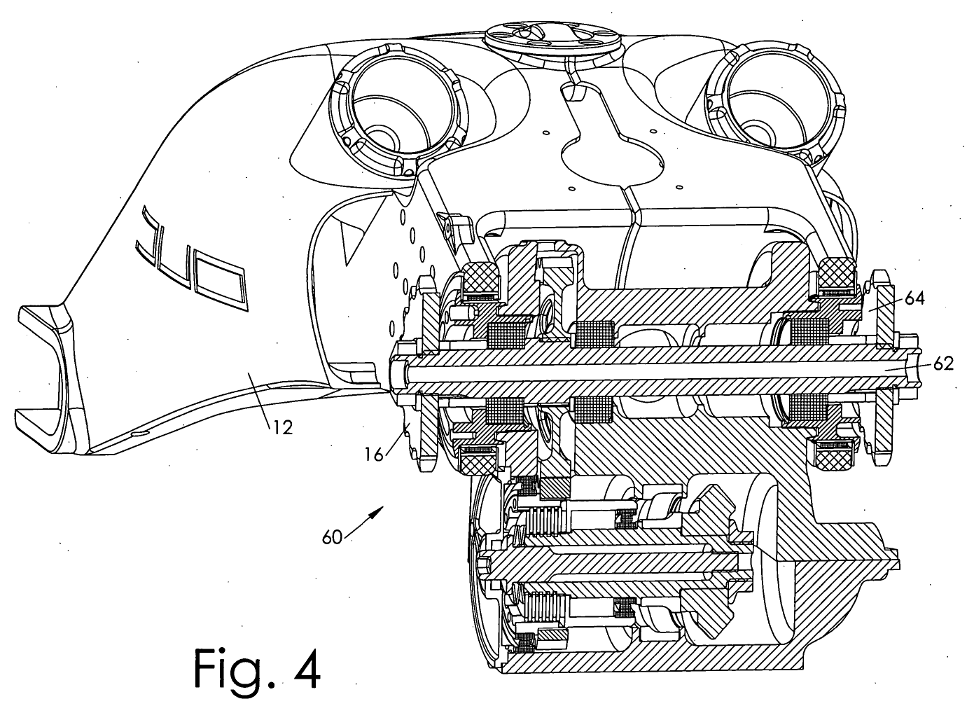

FIG. 4 illustrates another embodiment of an engine 60 and swingarm 12 in which the swingarm pivot is coaxial with the sprocket shaft 62. In addition to the first chain sprocket 16 on one side of the motorcycle, there is also a second chain sprocket 64 on the other side of the motorcycle. The extended sprocket shaft 62 may ride in additional bearings 66 at the other side of the engine.

This extended sprocket shaft with dual sprockets, one at either end, enables the motorcycle to use dual drive chains, one on either side of the motorcycle, to provide symmetrical pull and other forces on the swingarm. The more symmetrical these forces are, the less the swingarm will tend to flex or torque. This enables the swingarm to be made lighter. It also enables the use of two, lighter chains (not shown) and correspondingly lighter sprockets front and rear (not shown). In some embodiments, the swingarm is substantially symmetrical.

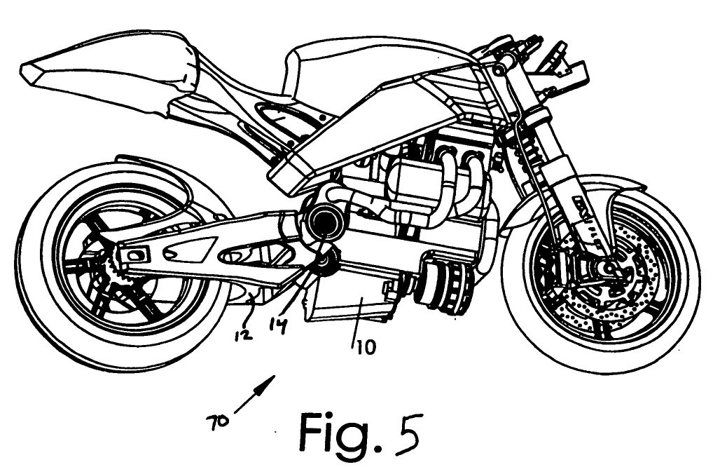

FIG. 5 illustrates one embodiment of a motorcycle 70 according to this invention. The motorcycle includes an engine 10 and a swingarm 12, in which the swingarm pivot is coaxial with the sprocket shaft 14.

### Conclusion

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention. CLMMS

1. An apparatus comprising:
a motorcycle engine including,
a cylinder block,
a crankcase coupled to the cylinder block,
a crankshaft disposed within the crankcase,
a gearbox coupled to be driven by the crankshaft, and
a sprocket shaft coupled to be driven by the gearbox;
a motorcycle swingarm including,
an elongated body, wheel mounting structure at a rear end of the elongated body for coupling to a wheel, and
pivot mounting structure at a front end of the elongated body coupled to the motorcycle engine at a swingarm pivot which is substantially coaxial with the sprocket shaft; and
a first sprocket coupled to the sprocket shaft outboard of the pivot mounting structure.

2. The apparatus of claim 1 wherein:
the sprocket shaft exits the motorcycle engine between the cylinder block and the crankcase.

3. The apparatus of claim 2 further comprising:
a slipper clutch coupling the sprocket shaft to the gearbox.

4. The apparatus of claim 3 wherein:
the crankcase includes,
an upper crankcase half, and
a lower crankcase half coupled to the upper crankcase half; and
the slipper clutch is coupled to the crankcase between the upper and lower crankcase halves.

5. The apparatus of claim 4 wherein:
the slipper clutch is coupled to the gearbox by a bevel gear.

6. The apparatus of claim 1 further comprising:
a second sprocket coupled to the sprocket shaft outboard of the pivot mounting structure at an opposite side of the motorcycle engine from the first sprocket.

7. The apparatus of claim 1 wherein:
the swingarm is substantially symmetrical about a plane perpendicular to an axis of the sprocket shaft.

8. A motorcycle comprising:
an engine including,
a cylinder block,
a crankcase coupled to the cylinder block,
a crankshaft coupled to the crankcase,
a gearbox coupled to the crankcase and including a gear train coupled to be driven by the crankshaft,
a sprocket shaft coupled to be driven by the gearbox, and
a first sprocket coupled to the sprocket shaft;
a swingarm coupled to the engine at a swingarm pivot which is substantially coaxial with the sprocket shaft;
wherein the first sprocket is located on the sprocket shaft at a position axially beyond the swingarm.

9. The motorcycle of claim 8 wherein:
the swingarm pivot comprises bearings which are coupled to the engine.

10. The motorcycle of claim 9 wherein:
the swingarm pivot bearings are coupled to the engine by a bracket which threads into the engine.

11. The motorcycle of claim 9 wherein:
the swingarm pivot bearings are coupled to the engine at a location where the cylinder block meets the crankcase, such that a first portion of the swingarm pivot bearings are coupled to the cylinder block and a second portion of the swingarm pivot bearings are coupled to the crankcase.

12. The motorcycle of claim 8 further comprising:
a slipper clutch which couples the sprocket shaft to the gearbox.

13. The motorcycle of claim 12 wherein:
the sprocket shaft includes an input gear; and
the slipper clutch includes,
a first gear which couples to the gearbox, and
a second gear which couples to the input gear of the sprocket shaft.

14. The motorcycle of claim 8 further comprising:
a second sprocket coupled to the sprocket shaft at an end opposite from the first sprocket;
wherein the first and second sprockets are located on the sprocket shaft at respective positions which are axially beyond the swingarm at opposite sides of the engine.
